(19) United States
(12) Patent Application Publication
(10) Pub. No.: US 2025/0386758 A1
(43) Pub. Date: Dec. 25, 2025

(54) COMBINED SEEDER FOR FULL STRAW MULCHING CONDITION OPERATION

(71) Applicant: Nanjing Agricultural University, Nanjing (CN)

(72) Inventors: Ruiyin HE, Nanjing (CN); Zixiang WEI, Nanjing (CN); Yanfeng DING, Nanjing (CN); Jianfu SUN, Nanjing (CN); Ganghua LI, Nanjing (CN); Yinian LI, Nanjing (CN); Min ZHAO, Nanjing (CN); Jianqin GAO, Nanjing (CN); Weiguo MENG, Nanjing (CN); Qishuo DING, Nanjing (CN)

(73) Assignee: Nanjing Agricultural University, Nanjing (CN)

(21) Appl. No.: 18/931,118

(22) Filed: Nov. 11, 2024

(30) Foreign Application Priority Data
Jun. 25, 2024 (CN) 202410832405.5

(51) Int. Cl. A01C 7/06; A01C 5/06

(52) U.S. Cl. CPC A01C 7/06; A01C 5/062

(57) ABSTRACT

A combined seeder for full straw mulching condition operation includes a frame, where a seeding and fertilizing mechanism is arranged above the frame, a pre-sowing pressing mechanism is arranged below the frame, a mechanical transmission mechanism is arranged in the middle of the frame, the two ends of the mechanical transmission mechanism are respectively connected with the furrowing mechanism and the vertical rotary tillage mechanism, the vertical rotary tillage mechanism is arranged in front of the frame, and the furrowing mechanism and a seeding profiling mechanism are arranged behind the frame. Th combined seeder for full straw mulching condition operation can complete the strip vertical rotation, crushed soil leveling, side deep fertilization, pre-sowing suppression, strip monomer profiling sowing in clean areas, and other processes in one operation under the full straw mulching condition, which greatly improves the operation efficiency and alleviates the problem of the tension of crop rotation.

### CROSS REFERENCE TO THE RELATED APPLICATIONS

This application is based upon and claims priority to Chinese Patent Application No. 202410832405.5, filed on Jun. 25, 2024, the entire contents of which are incorporated herein by reference.

### TECHNICAL FIELD

The invention relates to the technical field of agricultural mechanization equipment, especially to a combined seeder for full straw mulching condition operation.

### BACKGROUND

Sowing is an important part of agricultural production, which has a significant impact on grain yield. At present, although there are many types of seeders with the function of multiple operations, the traditional rotary tillage seeding equipment has problems such as shallow tillage depth of sowing belt, grass blockage of soil-engaging parts, and seed drying when operating under full straw mulching conditions, some machines fail to take into account the needs of furrowing operations under the paddy-upland rotation mode.

The existing technology has the following defects and deficiencies:

The utility model with a publication number of CN202021315818.X and named a vertical rotary soil preparation double suppression floating seeder is only suitable for dry farming and does not have the function of strip sowing and furrowing.

The utility model with a publication number of CN201921509665.X and named a rape straw mulching planter in a rice stubble field adopts a full-width horizontal rotary tillage, and the plow heads on both sides are used for furrowing.

The patent with a publication number of CN202210460090.7 and named a duplex drill 2023 Nov. 28, this machine adopts a full-width vertical rotary tillage and does not have the function of furrowing.

The utility model with a publication number of CN202222013211.1 and named a composite drill adopts a full-width vertical rotary tillage, and the transmission mechanism is complex and does not have the function of furrowing.

The utility model with a publication number of CN202121726454.9 and named a mechanical grain drill adopts a no-tillage strip planting and does not have the function of furrowing.

### SUMMARY

In order to overcome the above shortcomings, the invention provides a combined seeder for full straw mulching condition operation, which can complete strip vertical rotation, crushed soil leveling, side deep fertilization, pre-sowing suppression, strip monomer profiling sowing in clean areas and other processes, the whole machine operation has less soil movement, low energy consumption, deep tillage depth, less straw in the sowing belt, accurate and controllable amount of seed fertilizer, and good sowing quality, the problem of tight stubble can be solved in one operation, it also improves the sowing quality, lays a foundation for high grain yield, and conforms to the development concept of cost saving and efficiency increasing and double carbon emission reduction.

In order to achieve the above purpose, the invention provides a scheme of a combined seeder for full straw mulching condition operation, including a frame, a seeding and fertilizing mechanism is arranged above the frame, a pre-sowing pressing mechanism is arranged below the frame, and a mechanical transmission mechanism is arranged at a middle position of the frame; two ends of the mechanical transmission mechanism are respectively connected to a furrowing mechanism and a vertical rotary tillage mechanism, the vertical rotary tillage mechanism is arranged in front of the frame, and the furrowing mechanism and a seeding profiling mechanism are arranged behind the frame.

Preferably, the seeding and fertilizing mechanism includes a seed box and a fertilizer box set above the frame, and a plurality of fertilizer apparatuses are arranged below the fertilizer box, and a plurality of seeding apparatuses are arranged below the seed box;
the fertilizer apparatus is driven by a fertilizer discharging motor, and the seeding apparatus is driven by a seed discharging motor, rotating speeds of the fertilizer discharging motor and the seed discharging motor are adjusted by an intelligent control system according to a requirement of a seed fertilizer amount, the seed discharging motor and the fertilizer discharging motor are fixed on the frame, the fertilizer discharging motor and the seed discharging motor are connected to a reducer, and the reducer is fixed on the frame.

Preferably, the pre-sowing pressing mechanism includes a pressing roller set under the frame, two ends of the pressing roller are respectively connected to two rotating arms, one end of the rotating arms on both sides is hinged to the frame, the other end of the rotating arm is hinged to a lower end of an hydraulic cylinder, and an upper end of the hydraulic cylinder is connected to the frame;
a plurality of side deep fertilization furrow openers are arranged in front of the pressing roller and fixedly connected to the frame.

Preferably, the vertical rotary tillage mechanism includes a transmission box fixedly arranged on the frame, the transmission box is connected to a plurality of vertical rotary cutter shafts, the vertical rotary cutter shaft is sleeved with a meshing gear, the inferior of the vertical rotary cutter shaft is sleeved and connected to a cutter, and the cutter is connected to rake gear through a fixed pin.

Preferably, the mechanical transmission mechanism includes a central spiral bevel gear gearbox arranged on the frame, one end of the central spiral bevel gear gearbox is connected to a rake gear transmission box, and the other end of the central spiral bevel gear gearbox is connected to an intermediate transmission gearbox.

Preferably, the furrowing mechanism includes an installation frame fixedly connected to the frame, the installation frame is fixedly connected to a furrowing transmission gearbox, and the furrowing transmission gearbox is connected to the intermediate transmission gearbox through a universal coupling;

an output shaft of the furrowing transmission gearbox is fixedly connected to a rotating shaft, and the rotating shaft is fixedly sleeved with a furrowing cutter, a cleaning shovel is arranged in front of the furrowing cutter, and the cleaning shovel is fixedly arranged at a front end of the installation frame.

Preferably, the seeding profiling mechanism includes a plurality of profiling components, the profiling component includes a rear longitudinal rod and a front longitudinal rod, an end of the front longitudinal rod is fixedly connected to the frame, an upper crossbar and a lower crossbar are arranged between the front longitudinal rod and the rear longitudinal rod, and a spring is arranged between the lower crossbar and the upper crossbar.

Preferably, a lower end of the rear longitudinal rod is connected to a double-disc furrow opener through a rotating shaft, and an outer surface of the double-disc furrow opener is provided with an arc-shaped trench plate, the arc-shaped trench plate is penetrated by the rear longitudinal rod and a seed guiding tube, and an upper end of the seed guiding tube is connected to a seeding apparatus through a hose.

Preferably, the rear longitudinal rod is connected to a soil depth limiting wheel through a connecting rod, and the soil depth limiting wheel is arranged behind the double-disc furrow opener.

Preferably, a three-point suspension frame is fixed above a front end of the frame.

Therefore, the invention adopts a combined seeder with the above structure for full straw mulching condition operation, which has the following advantages:
(1) The invention combines the vertical rotary tillage mechanism with the pre-sowing repression mechanism for combined land preparation, which can construct a good seedbed quality, compared with the full-width operation, the strip operation significantly reduces the unit power consumption and reduces the operation cost.
(2) The post-active furrowing mechanism of the invention can take into account the different requirements of the paddy-upland rotation area and other areas.
(3) The invention can complete the strip vertical rotation, crushed soil leveling, side deep fertilization, pre-sowing suppression, strip monomer profiling sowing in clean areas, and other processes in one operation under the full straw mulching condition, which reduces the number and time of tractor landing, greatly improves the operation efficiency, alleviates the problem of the tension of crop rotation, and has a significant effect of cost saving and efficiency increasing.

The following is a further detailed description of the technical scheme of the invention through drawings and an embodiment.

### BRIEF DESCRIPTION OF THE DRAWINGS

FIG. 1 is a structural diagram of the combined seeder for full straw mulching condition operation in the embodiment of this invention.

FIG. 2 is a back-view structural diagram of the combined seeder for full straw mulching condition operation in the embodiment of this invention.

FIG. 3 is a structural diagram of the vertical rotary tillage mechanism of the combined seeder for full straw mulching condition operation in this invention.

FIG. 4 is a structural diagram of the profiling component of the combined seeder for full straw mulching condition operation in this invention.

FIG. 5 is a structural diagram of the mechanism of the double-disc furrow opener of the combined seeder for full straw mulching condition operation in this invention.

FIG. 6 is a structural diagram of the pressing roller of the combined seeder for full straw mulching condition operation in this invention.

Marks in the figures: 1, frame; 2, seed box; 3, fertilizer box; 4, fertilizer apparatus; 5, seeding apparatus; 6, fertilizer discharging motor; 7, seed discharging motor; 8, reducer; 9, pressing roller; 10, rotating arm; 11, hydraulic cylinder; 12, side deep fertilization furrow opener; 13, rake gear transmission box; 14, vertical rotary cutter shaft; 15, meshing gear; 16, vertical rotary cutter; 17, fixed pin; 18, rake gear; 19, central spiral bevel gear gearbox; 20, intermediate transmission gearbox; 21, installation frame; 22, open furrow transmission gearbox; 23, universal coupling; 24, rotating shaft; 25, furrowing cutter; 26, cleaning shovel; 27, profiling component; 28, rear longitudinal rod; 29, front longitudinal rod; 30, upper crossbar; 31, lower crossbar; 32, spring; 33, double-disc furrow opener; 34, arc-shaped trench plate; 35, seed guiding tube; 36, soil depth limiting wheel; 37, three-point suspension frame.

### DETAILED DESCRIPTION OF THE EMBODIMENTS

The following is a further explanation of the technical scheme of the invention through drawings and an embodiment.

Unless otherwise defined, the technical terms or scientific terms used in the invention should be understood by people with general skills in the field to which the invention belongs. The words first, second, and the like used in this invention do not represent any order, quantity, or importance, but are only used to distinguish different components. Similar words such as include or comprise mean that the elements or objects appearing before the word cover the elements or objects listed after the word and their equivalents, without excluding other elements or objects. Similar terms such as connecting or connected are not limited to physical or mechanical connections but can include electrical connections, whether direct or indirect. Up, down, left, right, etc. are only used to represent the relative positional relationship, when the absolute position of the described object changes, the relative positional relationship may also change accordingly.

### EMBODIMENT

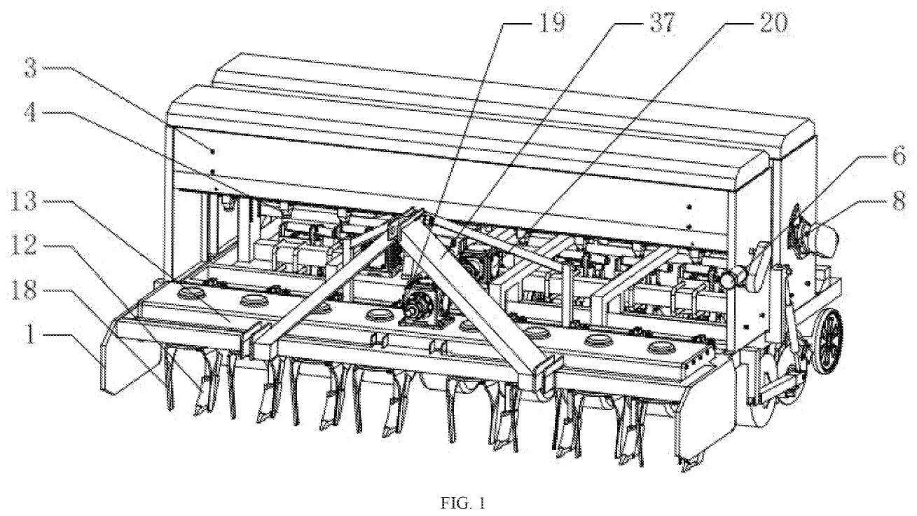

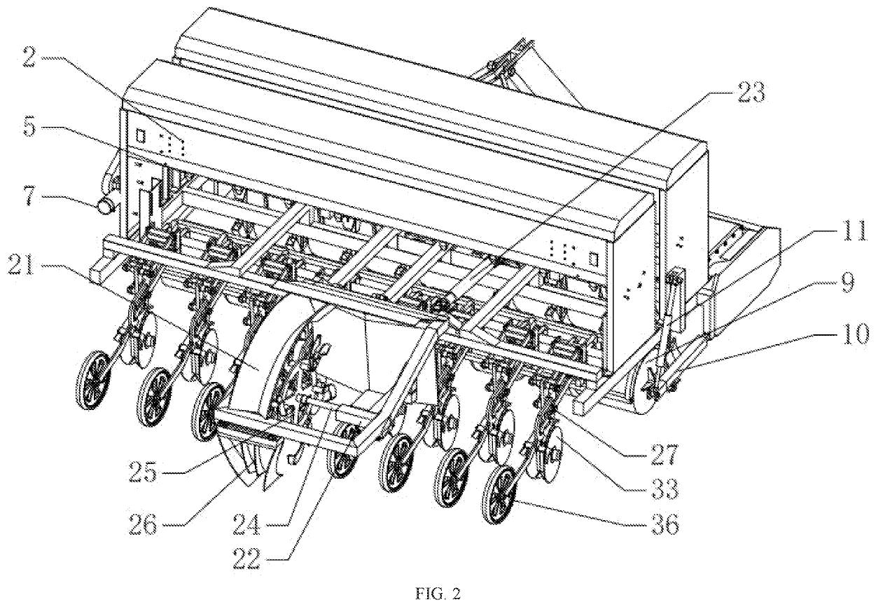

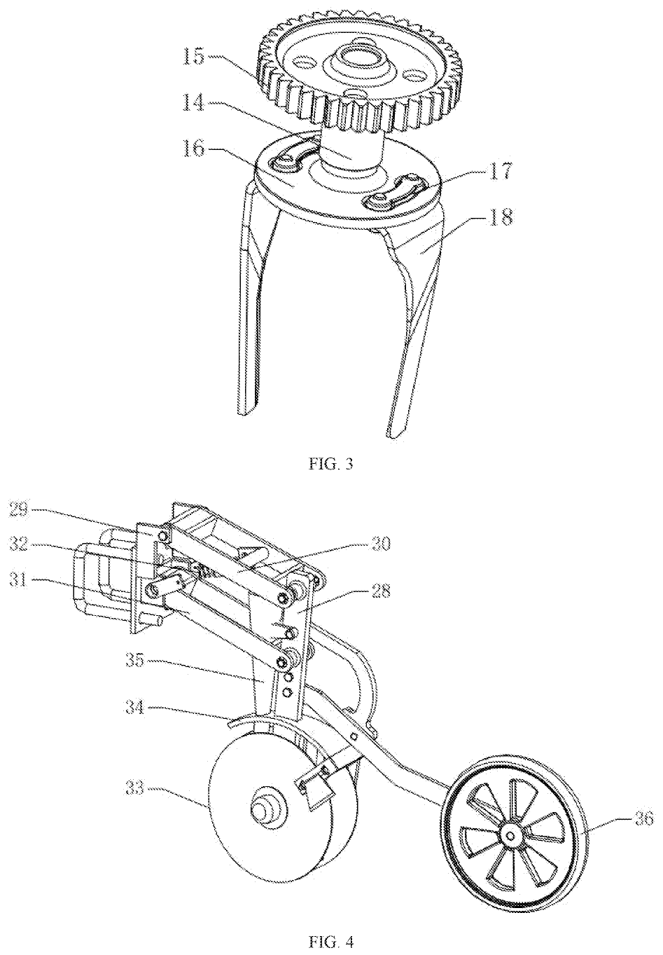

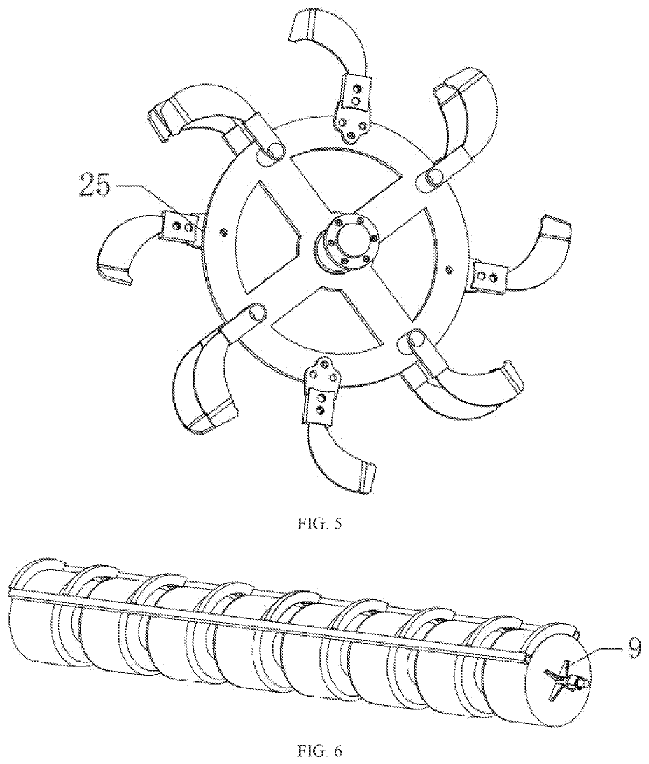

Refer to FIGS. 1-6, the invention provides a combined seeder for full straw mulching condition operation, including a frame 1, a seeding and fertilizing mechanism is arranged above the frame 1, a pre-sowing pressing mechanism is arranged below the frame 1, and a mechanical transmission mechanism is arranged at the middle position of the frame 1; the two ends of the mechanical transmission mechanism are respectively connected to a furrowing mechanism and a vertical rotary tillage mechanism, the vertical rotary tillage mechanism is arranged in front of the frame, and the furrowing mechanism and a seeding profiling mechanism are arranged behind the frame 1.

The seeding and fertilizing mechanism includes a seed box 2 and a fertilizer box 3 set above the frame 1, a plurality of fertilizer apparatuses 4 are arranged below the fertilizer box 3, and a plurality of seeding apparatuses 5 are arranged below the seed box 2; the fertilizer apparatus 4 is driven by a fertilizer discharging motor 6, and the seeding apparatus 5 is driven by a seed discharging motor 7, the rotating speeds of the fertilizer discharging motor 6 and the seed discharging motor 7 are adjusted by an intelligent control system according to the requirement of a seed fertilizer amount, the seed discharging motor 7 and the fertilizer discharging motor 6 are fixed on the frame 1, the fertilizer discharging motor 6 and the seed discharging motor 7 are connected to a reducer 8, and the reducer 8 is fixed on the frame. The reducer 8 controls the speeds of fertilizer and seeding of the fertilizer apparatuses 4 and the seeding apparatuses 5.

The pre-sowing pressing mechanism includes a pressing roller 9 set under the frame 1, the two ends of the pressing roller 9 are respectively connected to two rotating arms 10, one end of the rotating arms 10 on both sides is hinged to the frame 1, the other end of the rotating arm 10 is hinged to the lower end of an hydraulic cylinder 11, and the upper end of the hydraulic cylinder 11 is connected to the frame 1, the expansion of the hydraulic cylinder 11 drives the rotating arms 10 to rotate at a certain angle to control the crushing depth of the pressing roller 9. A plurality of side deep fertilization furrow openers 12 are arranged in front of the pressing roller 9, and a plurality of side deep fertilization furrow openers 12 are fixedly connected to the frame 1.

The vertical rotary tillage mechanism includes a rake gear transmission box 13 arranged on the frame 1, a plurality of vertical rotary cutter shafts 14 are connected to the rake gear transmission box 13, the vertical rotary cutter shaft 14 is sleeved with a meshing gear 15, the inferior of the vertical rotary cutter shaft 14 is sleeved and connected to a vertical rotary cutter 16, and a rake gear 18 is connected to the vertical rotary cutter 16 through a fixed pin 17. The rake gear transmission box 13 can drive multiple meshing gears 15 to rotate, and then drive multiple rake gears 18 to rotate for rotary tillage.

The mechanical transmission mechanism includes a central spiral bevel gear gearbox 19 arranged on the frame 1, one end of the central spiral bevel gear gearbox 19 is connected to the rake gear transmission box 13, and the other end of the central spiral bevel gear gearbox 19 is connected to an intermediate transmission gearbox 20. The power output shaft of the tractor outputs the power to the central spiral bevel gear gearbox 19, and the central spiral bevel gear gearbox 19 transmits the power to the rake gear transmission box 13, driving the vertical rotary tillage mechanism to complete the establishment of the rotary cleaning straw operation, and then through the intermediate transmission gearbox 20 and the universal coupling 23, the power is transmitted to the furrowing transmission gearbox 22, and the furrowing mechanism is driven to complete the furrowing operation.

The furrowing mechanism includes an installation frame 21 fixedly connected to the frame 1, the installation frame 21 is fixedly connected to a furrowing transmission gearbox 22, and the furrowing transmission gearbox 22 is connected to the intermediate transmission gearbox 20 through a universal coupling 23. An output shaft of the furrowing transmission gearbox 22 is fixedly connected to a rotating shaft 24, and the rotating shaft 24 is fixedly sleeved with a furrowing cutter 25, the furrowing cutter 25 is driven by the furrowing transmission gearbox 22 for ditching furrow, a cleaning shovel 26 is arranged in front of the furrowing cutter 25, and the cleaning shovel 26 is fixedly arranged at the front end of the installation frame 21, and the cleaning shovel 26 cleans the furrow.

The seeding profiling mechanism includes a plurality of profiling components 27, the profiling component 27 includes a rear longitudinal rod 28 and a front longitudinal rod 29, the end of the front longitudinal rod 29 is fixedly connected to the frame 1 by U-shaped bolts, which is easy to disassemble and install, and the row spacing and sowing depth are adjustable. An upper crossbar 30 and a lower crossbar 31 are arranged between the front longitudinal rod 29 and the rear longitudinal rod 28, and a spring 32 is arranged between the lower crossbar 31 and the upper crossbar 30.

The lower end of the rear longitudinal rod 28 is connected to a double-disc furrow opener 33 through a rotating shaft, and the outer surface of the double-disc furrow opener 33 is provided with an arc-shaped trench plate 34, the arc-shaped trench plate 34 is penetrated by the rear longitudinal rod 28 and a seed guiding tube 35, and the upper end of the seed guiding tube 35 is connected to the seeding apparatus 5 through a hose. The rear longitudinal rod 28 is connected to the soil depth limiting wheel 36 through the connecting rod, and the soil depth limiting wheel 36 is set behind the double-disc furrow opener 33. By adjusting the installation position of the profiling components 27, it can meet the needs of dry direct seeding of various crops such as rape, wheat, and rice, and take into account the needs of furrowing under the paddy-upland rotation mode.

When used, the power output shaft of the tractor outputs power to the central spiral bevel gear gearbox 19, and the central spiral bevel gear gearbox 19 transmits power to the rake gear transmission box 13, and then drives multiple meshing gears 15 to rotate and drive multiple rake gears 18 of the vertical rotary tillage mechanism for axial rotary motion, clear straw and crush soil, and build a flat seedbed belt with the side deep fertilization furrow opener 12 and the pressing roller 9, and adjust the pressing depth through the hydraulic cylinder 11; then, the seeding apparatus 5 and the fertilizer apparatus 4 are driven by the seed discharging motor 7 and the fertilizer discharging motor 6 to complete the fertilizer and seed discharging operation. The amount of fertilizer is adjusted in real-time by the reducer 8. The fertilizer dropped by the fertilizer apparatus 4 falls directly into the soil, the seeds dropped by the seeding apparatus 5 falls into the seed guiding tube 35 through the hose, and then the double-disc furrow opener 33 is sown to the soil, and the soil depth limiting wheel 36 is used for soil covering and suppressing; the power is transmitted to the furrowing transmission gearbox 22 through the universal coupling 23, and then the furrowing cutter 25 is driven by the furrowing transmission gearbox 22 for ditching furrows, and the cleaning shovel 26 is used to clear the furrows.

Therefore, the invention adopts a combined seeder with the above structure for full straw mulching condition operation. Through the combination of vertical rotary tillage mechanism and pre-sowing suppression mechanism, the combined soil preparation can build a seed bed with good quality. Compared with the full-width operation, the strip planting and fertilization mechanism reduces the unit power consumption; the furrowing mechanism can take into account the different operation requirements of the paddy-upland rotation area and other areas; it can complete the strip vertical rotation, crushed soil leveling, side deep fertilization, pre-sowing suppression, strip monomer profiling sowing in clean areas and other processes in one operation under the full straw mulching condition, which reduces the number and time of tractor landing, greatly improves the operation efficiency, alleviates the problem of the tension of crop rotation, and has a significant effect of cost saving and efficiency increasing.

Finally, it should be noted that the above embodiment is only used to explain the technical scheme of the invention rather than to restrict it, although the invention is described in detail concerning the better embodiment, ordinary technicians in this field should understand that they can still modify or replace the technical scheme of the invention, and these modifications or equivalent replacements cannot make the modified technical scheme out of the spirit and scope of the technical scheme of the invention.

What is claimed is:

1. A combined seeder for a full straw mulching condition operation, comprising a frame, wherein a seeding and fertilizing mechanism is arranged above the frame, a pre-sowing pressing mechanism is arranged below the frame, and a mechanical transmission mechanism is arranged at a middle position of the frame; two ends of the mechanical transmission mechanism are respectively connected to a furrowing mechanism and a vertical rotary tillage mechanism, the vertical rotary tillage mechanism is arranged in front of the frame, and the furrowing mechanism and a seeding profiling mechanism are arranged behind the frame.

2. The combined seeder for the full straw mulching condition operation according to claim 1, wherein the seeding and fertilizing mechanism comprises a seed box and a fertilizer box, wherein the seed box and the fertilizer box are set above the frame, a plurality of fertilizer apparatuses are arranged below the fertilizer box, and a plurality of seeding apparatuses are arranged below the seed box; and
the plurality of fertilizer apparatuses are driven by a fertilizer discharging motor, the plurality of seeding apparatuses are driven by a seed discharging motor, a rotating speed of the fertilizer discharging motor and a rotating speed of the seed discharging motor are adjusted by an intelligent control system according to a requirement of a seed fertilizer amount, the seed discharging motor and the fertilizer discharging motor are fixed on the frame, the fertilizer discharging motor and the seed discharging motor are connected to a reducer, and the reducer is fixed on the frame.

3. The combined seeder for the full straw mulching condition operation according to claim 2, wherein the pre-sowing pressing mechanism comprises a pressing roller set under the frame, two ends of the pressing roller are respectively connected to two rotating arms, a first end of each of the two rotating arms on both sides is hinged to the frame, a second end of each of the two rotating arms is hinged to a lower end of a hydraulic cylinder, and an upper end of the hydraulic cylinder is connected to the frame; and
a plurality of side deep fertilization furrow openers are arranged in front of the pressing roller and fixedly connected to the frame.

4. The combined seeder for the full straw mulching condition operation according to claim 3, wherein the vertical rotary tillage mechanism comprises a transmission box fixedly arranged on the frame, the transmission box is connected to a plurality of vertical rotary cutter shafts, each of the plurality of vertical rotary cutter shafts is sleeved with a meshing gear, an inferior of each of the plurality of vertical rotary cutter shafts is sleeved and connected to a cutter, and the cutter is connected to a rake gear through a fixed pin.

5. The combined seeder for the full straw mulching condition operation according to claim 4, wherein the mechanical transmission mechanism comprises a central spiral bevel gear gearbox arranged on the frame, wherein a first end of the central spiral bevel gear gearbox is connected to a rake gear transmission box, and a second end of the central spiral bevel gear gearbox is connected to an intermediate transmission gearbox.

6. The combined seeder for the full straw mulching condition operation according to claim 5, wherein the furrowing mechanism comprises an installation frame fixedly connected to the frame, wherein the installation frame is fixedly connected to a furrowing transmission gearbox, and the furrowing transmission gearbox is connected to the intermediate transmission gearbox through a universal coupling; and
an output shaft of the furrowing transmission gearbox is fixedly connected to a first rotating shaft, the first rotating shaft is fixedly sleeved with a furrowing cutter, a cleaning shovel is arranged in front of the furrowing cutter, and the cleaning shovel is fixedly arranged at a front end of the installation frame.

7. The combined seeder for the full straw mulching condition operation according to claim 6, wherein the seeding profiling mechanism comprises a plurality of profiling components, wherein each of the plurality of profiling components comprises a rear longitudinal rod and a front longitudinal rod, an end of the front longitudinal rod is fixedly connected to the frame, an upper crossbar and a lower crossbar are arranged between the front longitudinal rod and the rear longitudinal rod, and a spring is arranged between the lower crossbar and the upper crossbar.

8. The combined seeder for the full straw mulching condition operation according to claim 7, wherein a lower end of the rear longitudinal rod is connected to a double-disc furrow opener through a second rotating shaft, an outer surface of the double-disc furrow opener is provided with an arc-shaped trench plate, the arc-shaped trench plate is penetrated by the rear longitudinal rod and a seed guiding tube, and an upper end of the seed guiding tube is connected to each of the plurality of seeding apparatuses through a hose.

9. The combined seeder for the full straw mulching condition operation according to claim 8, wherein the rear longitudinal rod is connected to a soil depth limiting wheel through a connecting rod, and the soil depth limiting wheel is arranged behind the double-disc furrow opener.

10. The combined seeder for the full straw mulching condition operation according to claim 9, wherein a three-point suspension frame is fixed above a front end of the frame.
